(19) United States
(12) Patent Application Publication
(10) Pub. No.: US 2005/0147013 A1
(43) Pub. Date: Jul. 7, 2005

(54) Two-dimensional light-receiving element, optical reproducing apparatus and optical recording and reproducing apparatus

(75) Inventors: Kiyoshi Tateishi, Saitama (JP); Hideki Kobayashi, Saitama (JP)

Correspondence Address: NIXON & VANDERHYE, PC, 1100 N GLEBE ROAD, 8TH FLOOR, ARLINGTON, VA, 22201-4714, US

(73) Assignee: PIONEER CORPORATION, Tokyo (JP)

(21) Appl. No.: 11/028,862

(22) Filed: Jan. 5, 2005

(30) Foreign Application Priority Data
Jan. 6, 2004 (JP) 2004-000818

(51) Int. Cl. G11B 7/00

(52) U.S. Cl. 369/103; 369/53.31; 369/59.1

(57) ABSTRACT

A marker for position detection is included in a spatially-modulated pattern of recording information, and an object light is generated and the recording information is recorded on a recording medium. From a detected light from the recording medium, information data corresponding to the recording information and marker data are detected by a two-dimensional sensor. By making unit light-receiving element sizes of marker detecting area and data detecting area of the two-dimensional sensor different, detection accuracy of the marker position can be improved. In addition, by making a bit length of the detected marker data longer than a bit length of the information data, the detection accuracy of the marker position can also be improved. Further, by outputting the detected marker data prior to the information data, a process such as a marker position detection and a geometrical correction can be started in an early stage, and reproduction of the recording information can rapidly be performed.

### BACKGROUND OF THE INVENTION

1. Field of the Invention

The present invention relates to a two-dimensional light-receiving element which receives a modulated light by a two-dimensional image in order to record and reproduce information, and an optical recording and reproducing apparatus which uses the light-receiving element.

2. Description of the Related Art

There is known a hologram recording technique which records information to be recorded on a holographic recording medium (hereinafter simply referred to as a “recording medium”) as interference fringes. One method for this technique uses the information to be recorded to spatially modulate a light from a light source to generate an object light. The apparatus irradiates the recording medium with an object light and a reference light. The object light and the reference light generate interference fringes on the recording medium, and the interference fringes are recorded in a recording layer of the recording medium. On the other hand, for reproduction, the interference fringes recorded on the recording medium are irradiated only with the reference light. A two-dimensional sensor detects a detected light from the recording medium to reproduce the recording information.

In hologram recording, there is known a technique of including a marker for position detection in the spatially-modulated pattern in addition to an image pattern corresponding to the recording information when the light from the light source is modulated by a spatial modulator. At the time of reproducing the information, the marker position is detected by the detected light from the hologram recording medium, and based on the detected marker position, geometrical correction of the data image corresponding to the recording information is performed. Thereby, a positional shift of a detected image on the two-dimensional sensor caused due to an error of an optical system, shrinkage of the hologram recording medium and the like can be corrected.

Examples of the above-mentioned hologram recording and reproducing apparatus using the marker for the position detection are disclosed in Japanese Patent Applications Laid-open under Nos. 11-16374 and 2000-122012.

### SUMMARY OF THE INVENTION

The present invention has been achieved in order to solve the above problems. It is an object of this invention to provide a two-dimensional light-receiving element capable of detecting a marker position with high accuracy. It is another object of the present invention to provide a two-dimensional light-receiving element, and an optical reproducing apparatus and an optical recording and reproducing apparatus capable of accurately and rapidly reproducing recording information data by performing geometrical correction of a detected image based on the marker position.

According to one aspect of the present invention, there is provided a two-dimensional light-receiving element which receives a detected light optically-modulated in accordance with a spatially-modulated pattern including a recording information image pattern corresponding to recording information and a marker, including: a data detecting area which receives a component corresponding to the recording information image pattern in the detected light; and a marker detecting area which receives a component corresponding to the marker in the detected light, wherein a unit light-receiving element size of the marker detecting area is different from a unit light-receiving element size of the data detecting area.

The above two-dimensional light-receiving element receives the detected light optically-modulated by the spatially-modulated pattern including the recording information image pattern and the marker. The recording information image pattern may be such a pattern that a recording signal is modulated to the two-dimensional image pattern, and the pattern is displayed on the spatial modulator, for example. On the spatial modulator, the marker is displayed in addition to the recording information image pattern, and the light from the light source is modulated. The modulated light is recorded on the recording medium as interference fringes, for example, and the detected light is received by the two-dimensional light-receiving element. The two-dimensional light-receiving element includes the data detecting area which receives the component corresponding to the recording information image pattern, and the marker detecting area which receives the component corresponding to the marker in the detected light. The unit light-receiving element size of the marker detecting area is different from the unit light-receiving element size of the data detecting area. Therefore, there can be difference between the detection accuracy of the marker position and the detection accuracy of the recording information image pattern, and the detection accuracy of the marker position can be improved. Thereby, the reproduction accuracy of the information data corresponding to the recording information can be improved, too.

In a preferred example, the unit light-receiving element size of the marker detecting area may be smaller than the unit light-receiving element size of the data detecting area. Thereby, a spatial resolution of the marker detecting area can be larger than the spatial resolution of the data detecting area, and the detection accuracy of the marker position can be improved.

In another preferred example, the unit light-receiving element size of the marker detecting area may be larger than the unit light-receiving element size of the data detecting area. By making the marker detecting area large, the light-receiving quantity is increased, and an S/N ratio is also increased. Thereby, the detection accuracy of the marker position can be improved.

According to another aspect of the present invention, there is provided an optical reproducing apparatus including: a two-dimensional light-receiving element which receives a detected light optically-modulated in accordance with a spatially-modulated pattern including a recording information image pattern corresponding to recording information and a marker; and a reproducing unit which reproduces the recording information based on a detecting signal outputted from the two-dimensional light-receiving element, wherein the two-dimensional light-receiving element includes: a data detecting area which receives a component corresponding to the recording information image pattern in the detected light; and a marker detecting area which receives a component corresponding to the marker in the detected light, wherein a unit light-receiving element size of the marker detecting area is different from a unit light-receiving element size of the data detecting area.

According to another aspect of the present invention, there is provided an optical reproducing apparatus including: a two-dimensional light-receiving element which receives a detected light optically-modulated in accordance with a spatially-modulated pattern including a recording information image pattern corresponding to recording information and a marker; a detecting unit which receives a component corresponding to the recording information image pattern in the detected light to output detected information data, and receives a component corresponding to the marker in the detected light to output detected marker data; and a reproducing unit which reproduces the recording information based on the detected information data and the detected marker data, wherein a bit length of the detected marker data is longer than a bit length of the detected information data.

According to similar aspect of the present invention, there is provided an optical reproducing method including: a process which receives, by a two-dimensional light-receiving element, a detected light optically-modulated in accordance with a spatially-modulated pattern including a recording information image pattern corresponding to recording information and a marker; a process which receives a component corresponding to the marker in the detected light and outputs detected marker data of a predetermined bit length; a process which receives a component corresponding to the recording information image pattern in the detected light and outputs detected information data of a bit length shorter than the predetermined bit length; and a process which reproduces the recording information based on the detected information data and the detected marker data.

According to the above optical reproducing apparatus and method, the two-dimensional light-receiving element receives the detected light optically-modulated by the spatially-modulated pattern including the recording information image pattern and the marker. The detected information data corresponding to the recording information image pattern is outputted from the detected light, and the detected marker data corresponding to the marker is outputted. By making the bit length of the detected marker data longer than the bit length of the detected information data, the detection accuracy of the marker position can be improved. In addition, by shortening the bit length of the information data, the transmission speed of the information data can be increased.

In one mode of the above optical reproducing apparatus, the detecting unit may include: an A/D converter which converts a detected information signal and a detected marker signal outputted from the two-dimensional light-receiving element into detected information data and detected marker data of a predetermined bit number, respectively; and a unit which reduces the bit number of the detected information data to supply the detected information data of reduced bits number to the reproducing unit and supplies the detected marker data of the predetermined bit number to the reproducing unit. Thereby, by using the identical A/D converter, the detected marker data of the long bit length and the detected information data of the short bit length can be generated.

According to still another aspect of the present invention, there is provided an optical reproducing apparatus including: a two-dimensional light-receiving element which receives a detected light optically-modulated in accordance with a spatially-modulated pattern including a recording information image pattern corresponding to recording information and a marker; a detecting unit which receives a component corresponding to the recording information image pattern in the detected light to output detected information data, and receives a component corresponding to the marker in the detected light to output detected marker data; and a reproducing unit which reproduces the recording information based on the detected information data and the detected marker data, wherein the detecting unit outputs the detected marker data prior to the detected information data.

According to similar aspect of the present invention, there is provided an optical reproducing method including: a process which receives, by a two-dimensional light-receiving element, a detected light optically-modulated in accordance with a spatially-modulated pattern including a recording information image pattern corresponding to recording information and a marker; a process which receives a component corresponding to the marker in the detected light and outputs detected marker data; a process which receives a component corresponding to the recording information image pattern in the detected light after outputting of the detected marker data, and outputs detected information data; and a process which reproduces the recording information based on the detected information data and the detected marker data.

According to the above optical reproducing apparatus and method, the two-dimensional light-receiving element receives the detected light optically-modulated by the spatially-modulated pattern including the recording information image pattern and the marker. The detected information data corresponding to the recording information image pattern is outputted from the detected light, and the detected marker data corresponding to the marker is outputted. The detected marker data is outputted prior to the detected information data. Therefore, the marker position detection process can be started soon by using the detected marker data, and the subsequent reproduction process of the information data can rapidly be executed.

According to still another aspect of the present invention, there is provided an optical recording and reproducing apparatus including: a recording unit which records recording information on a recording medium as a recording information image pattern; a two-dimensional light-receiving element which receives a detected light optically-modulated in accordance with a spatially-modulated pattern including a recording information image pattern corresponding to the recording information and a marker; a detecting unit which receives a component corresponding to the recording information image pattern in the detected light to output detected information data, and receives a component corresponding to the marker in the detected light to output detected marker data; and a reproducing unit which reproduces the recording information based on the detected information data and the detected marker data, wherein a bit length of the detected marker data is longer than a bit length of the detected information data.

According to the above optical recording and reproducing apparatus, the two-dimensional light-receiving element receives the detected light optically-modulated by the spatially-modulated pattern including the recording information image pattern and the marker. The detected information data corresponding to the recording information image pattern is outputted from the detected light, and the detected marker data corresponding to the marker is outputted. By making the bit length of the detected marker data larger than the bit length of the detected information data, the detection accuracy of the marker position can be improved. In addition, by shortening the bit length of the information data, the transmission speed of the information data can be increased.

According to still another aspect of the present invention, there is provided an optical recording and reproducing apparatus including: a recording unit which records recording information on a recording medium as a recording information image pattern; a two-dimensional light-receiving element which receives a detected light optically-modulated in accordance with a spatially-modulated pattern including a recording information image pattern corresponding to the recording information and a marker; a detecting unit which receives a component corresponding to the recording information image pattern in the detected light to output detected information data, and receives a component corresponding to the marker in the detected light to output detected marker data; a reproducing unit which reproduces the recording information based on the detected information data and the detected marker data, wherein the detecting unit outputs the detected marker data prior to the detected information data.

According to the above optical recording and reproducing apparatus, the two-dimensional light-receiving element receives the detected light optically-modulated by the spatially-modulated pattern including the recording information image pattern and the marker. The detected information data corresponding to the recording information image pattern is outputted from the detected light, and the detected marker data corresponding to the marker is outputted. At that time, the detected marker data is outputted prior to the detected information data. Therefore, the marker position detection process can be started soon by using the detected marker data, and the subsequent reproduction process of the information data can rapidly be executed.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a diagram showing the configuration of an optical system in a hologram recording and reproducing apparatus according to an embodiment of the present invention;

FIGS. 2(a) and 2(b) are diagram showing an example of a two-dimensional digital modulation signal for recording information;

FIG. 3 is a block diagram schematically showing the configuration of a signal processing system in a hologram recording and reproducing apparatus according to an embodiment;

FIG. 4 is a diagram showing an example of markers displayed on a spatial modulator;

FIGS. 5(a) and 5(b) are plan views of a first example of a two-dimensional sensor according to the embodiment;

FIG. 6 is a plan view of a second example of the two-dimensional sensor according to the embodiment;

FIGS. 7(a) and 7(b) are plan views of a third example of the two-dimensional sensor according to the embodiment;

FIG. 8 is a plan view of a fourth example of the two-dimensional sensor according to the embodiment;

FIGS. 9(a) to 9(c) are plan views of still another example of the two-dimensional sensor according to the embodiment;

FIG. 10 is a block diagram showing an example of a configuration of the two-dimensional sensor and a data detecting unit;

FIG. 11 is a circuit diagram showing a configuration of an operation unit in the data detecting unit;

FIG. 12 shows an example of data storage manner in a memory in the data detecting unit;

FIG. 13 is a block diagram showing another example of the configuration of the two-dimensional sensor and the data detecting unit; and

FIG. 14 is a flow chart of a data detection process.

### DETAILED DESCRIPTION OF THE PREFERRED EMBODIMENTS

Preferred embodiments of the present invention will be described below with reference to the drawings.

(Recording and Reproducing Apparatus)

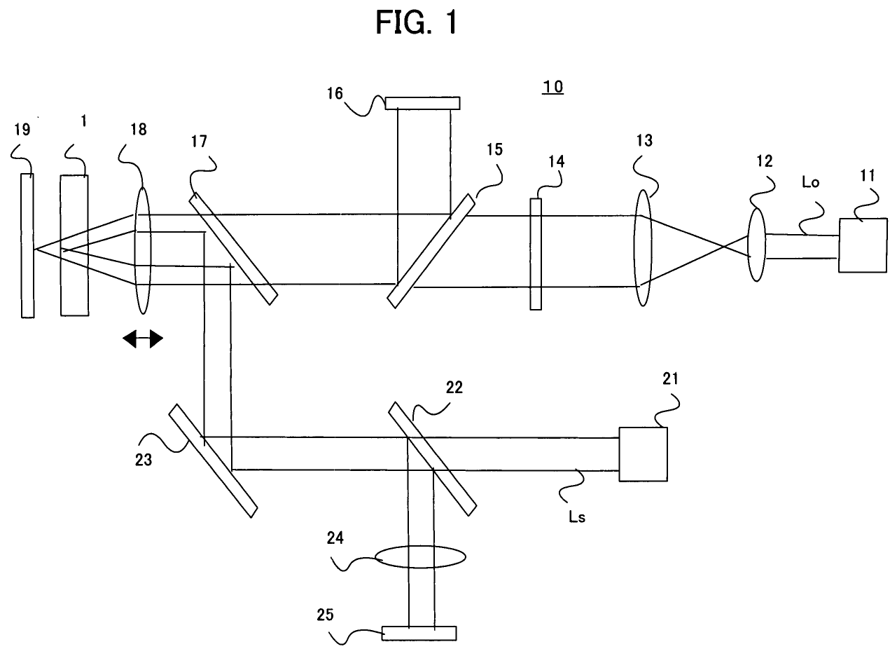

FIG. 1 shows the configuration of an optical system placed in a pickup of a hologram recording and reproducing apparatus according to an embodiment of the present invention. In FIG. 1, a pickup 10 includes a recording and reproducing laser 11 that generates a laser light for recording and reproducing information and a servo laser 21 that generates a red laser light for focus servo control.

When information is recorded, a light beam Lo is first emitted by the recording and reproducing laser 11. A beam expander constituted by lenses 12 and 13 increases the diameter of the light beam Lo and inputs the light beam Lo to a spatial modulator 14. The spatial modulator 14 can be constituted by, for example, a liquid crystal element. The spatial modulator 14 has a plurality of pixels arranged like a lattice.

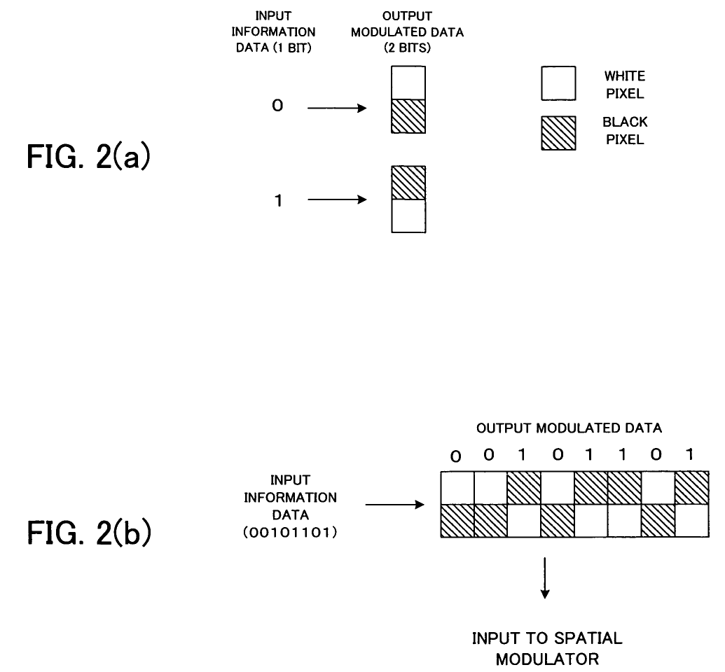

The spatial modulator 14 displays a pattern of white and black pixels obtained by executing a two-dimensional digital modulation of information to be recorded. The spatial modulator 14 uses the pattern to spatially modulate the light beam Lo. FIG. 2 shows an example of the two-dimensional modulation executed by the spatial modulator 14. In this example, as shown in FIG. 2(a), digital input information data, that is, information data “0” and “1” to be recorded on a recording medium 1, is expressed using a combination of white and black pixels. An array of white and black pixels arranged in this order in a vertical direction corresponds to the input information data “0”. An array of black and white pixels arranged in this order in the vertical direction corresponds to the input information data “1”. In this example, 1-bit input information data is converted into 2-bit (2-pixel) two-dimensional modulated data. This example is thus called a 1:2 differential modulation.

FIG. 2(b) shows, as output modulated data, two-dimensional modulated data obtained by subjecting input information data “00101101” to a two-dimensional digital conversion. Namely, the modulated image pattern constituted by white and black pixels is displayed on the spatial modulator 14 as output modulated data. The light beam Lo incident on the spatial modulator 14 is transmitted through the white pixel portions of the spatially-modulated image pattern. The light beam Lo is blocked in the black pixel portions. Consequently, the spatial modulator 14 emits the light beam Lo optically modulated by the spatially-modulated image pattern. This is an example of a spatial modulation, and the application of the present invention is not limited to the above modulation system. It is possible to use any two-dimensional modulation system such as what is called a 2:4 modulation system that converts 2-bit input information data into 4-bit two-dimension modulated data, provided that input information data can be converted into two-dimensional modulated image pattern and that the spatial modulator can be driven to spatially modulate a light beam.

The light beam Lo spatially modulated by the spatial modulator 14 passes through a half mirror 15 and a dichroic mirror 17. An objective lens 18 focuses the light beam Lo, and the holographic recording medium 1 is irradiated with the focused light beam. The dichroic mirror 17 has wavelength selectivity. The dichroic mirror 17 allows the light beam Lo from the recording and reproducing laser 11 to pass through, but reflects the light beam Ls from the servo laser 21.

A mirror 19 is provided behind the recording medium 1 (opposite the objective lens 18). The light beam Lo focused by the objective lens 18 passes through the recording medium 1, and is reflected by the mirror 19 and then enters the recording medium 1 again. Accordingly, interference fringes are formed in the recording medium 1 by the light beam entering the recording medium 1 directly from the objective lens 18 and the light beam entering the medium 1 after being reflected by the mirror 19.

The light beam Lo entering the medium 1 after being reflected by the mirror 19 passes through the dichroic mirror 17. The light beam Lo is reflected by a half mirror 15 and then received by a two-dimensional sensor 16. The two-dimensional sensor 16 may be, for example, a CCD array or a CMOS sensor. The two-dimensional sensor 16 outputs an electric signal corresponding to the quantity of the incident light.

On the other hand, at the time of reproducing information, the spatial modulator 14 is controlled to a non-modulation state (that is, a total light transmission state). Accordingly, the light beam Lo emitted by the recording and reproducing laser 11 is applied to the recording medium 1 through the half mirror 15, the dichroic mirror 17, and the objective lens 18 without being modulated by the spatial modulator 14. This light becomes a reproduction reference light. In the recording medium 1, a detected light is generated by the reproduction reference light and the interference fringes recorded on the recording medium 1. The detected light passes through the objective lens 18 and dichroic mirror 17. The detected light is then reflected by the half mirror 15 and enters the two-dimensional sensor 16. Thus, a spatially-modulated image pattern of white and black pixels created at the time of recording is formed on the two-dimensional sensor 16, and this pattern is detected to obtain reproduced information corresponding to the recording information.

On the other hand, the light beam Ls emitted by the servo laser 21 (hereinafter referred to as the “servo beam”) passes through a half mirror 22 and is then reflected by a mirror 23. The light beam Ls is further reflected by the dichroic mirror 17 and is irradiated on the objective lens 18. The objective lens 18 focuses the servo beam Ls as well as the light beam Lo from the recording and reproducing laser 11 on the recording medium 1. The servo beam Ls is reflected by a reflection layer provided in a back surface of the recording medium 1. The servo beam Ls is further reflected by the dichroic mirror 17, the mirror 23, and the half mirror 22. Then, a cylindrical lens 24 gives, to the servo beam Ls, astigmatism corresponding to the amount of shift from a focal position. A quadruple photo detector 25 then receives the servo beam Ls. The quadruple photo detector 25 outputs an electric signal corresponding to the quantity of light received. Accordingly, by using the quadruple photo detector 25 to detect the amount of astigmatism, it is possible to obtain a focus error indicative of the amount of shift from the focal position.

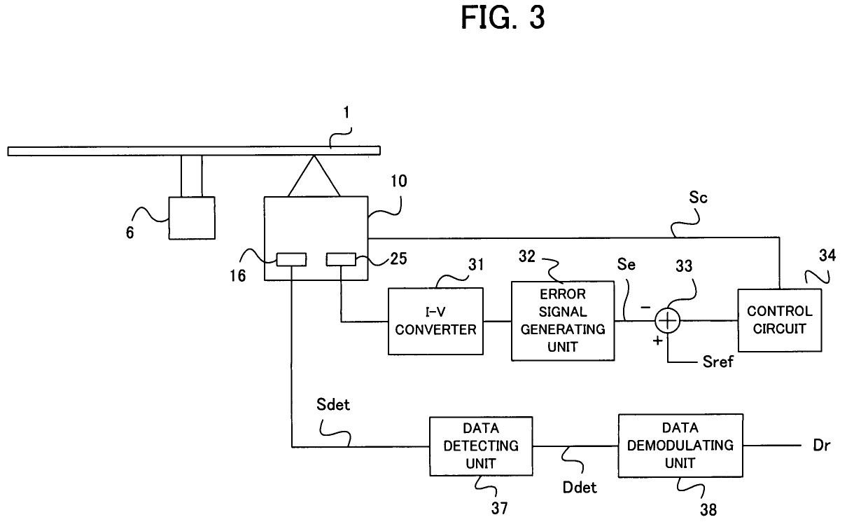

Now, description will be given of a signal processing system in the hologram recording and reproducing apparatus according to the present embodiment. FIG. 3 is a block diagram schematically showing the configuration of the signal processing system of the hologram recording and reproducing apparatus according to the first embodiment.

The signal processing system of the hologram recording and reproducing apparatus is roughly divided into a reproduction system that reproduces recording information to output reproduced information data and a servo system that performs servo control such as a focus servo, a tracking servo and a spindle servo. FIG. 3 schematically shows the configuration of the reproduction system and a focus servo system included in the servo system. In FIG. 3, the reproduction system is constituted by a data detecting unit 37 and a data demodulating unit 38. Further, the servo system is constituted by an I-V converter 31, an error signal generating unit 32, an adder 33, and a control circuit 34. It is noted that the servo system includes the tracking servo, the focus servo and the like.

In FIG. 3, the recording medium 1 is shaped like a disc. A spindle motor 6 controls the rotation of the recording medium 1. The recording medium 1 controllably rotated by the spindle motor 6 is irradiated with the recording and reproducing light beam Lo from the pickup 10. The pickup 10 includes the optical system illustrated in FIG. 1. As shown in FIG. 1, in the pickup 10, the recording medium 1 is irradiated with the light beam Lo emitted by the recording and reproducing laser 11. The two-dimensional sensor 16 receives the detected light from the recording medium 1. Output data from the two-dimensional sensor 16 is mainly processed by the reproduction system. Further, the recording medium 1 is also irradiated with the light beam Ls emitted by the servo laser 21. The quadruple photo detector 25 receives the return light beam. An output signal from the quadruple photo detector 25 is processed by the focus servo system.

First, the operation of the reproduction system will be described. In FIG. 3, the two-dimensional sensor 16 in the pickup 10 outputs a two-dimensional image signal (hereinafter referred to as “detected image signal Sdet”) corresponding to the quantity of light received.

The data detecting unit 37 generates marker detected image data corresponding to the markers and information detected image data corresponding to the information data on the basis of the analog detected image signal Sdet outputted from the two-dimensional sensor 16, and supplies them to the data demodulating unit 38. Markers are information required to identify one unit (one page) of information recorded on the recording medium 1. The marker is normally configured as an image portion having a predetermined shape. The markers are added to the recording information before the information is recorded on the recording medium 1. During reproduction, by detecting the markers, the one unit (one page) of the recording information is specified, and the recording information included in the one page is reproduced.

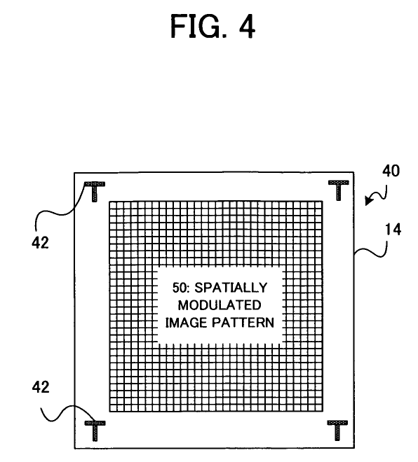

Specifically, the markers are added to the spatially-modulated image pattern displayed on the spatial modulator 14. FIG. 4 shows an example of a spatially-modulated image pattern including the markers. In the example shown in FIG. 4, the spatially-modulated image pattern 50 is displayed substantially at the center of a display area of the spatial modulator 14. Further, T-shaped markers 42 are displayed outside the spatially-modulated image pattern 50 and at the four corners of the display area of the spatial modulator 14. The spatial modulator 14 spatially modulates recording information received from a recording signal processing system (not shown) to generate the spatially-modulated image pattern 50. The spatial modulator 14 displays the spatially-modulated image pattern 50 in the display area as shown in FIG. 4. Moreover, the spatial modulator 14 displays the predetermined markers 42 at the predetermined positions in the display area. As schematically shown in FIG. 4, a displayed image 40 including the spatially-modulated image pattern 50 and the markers 42 is thus displayed in the display area of the spatial modulator 14.

The data demodulating unit 38 detects the marker position on the basis of the marker detected image data. The detection of the marker position is performed by template matching. The template matching is a method of matching the marker detected image data with the image data forming the marker to detect the marker position in the marker detected image data. Since the method is known, a detailed explanation thereof is omitted.

Based on the detected marker position, the data demodulating unit 38 performs the geometrical correction of the information detected image data by a technique such as an affine transformation, for example. The geometrical correction is the correction of misalignment in the pixel position which may occur during image recording and reproduction. During recording, an image is transferred from the spatial modulator 14 to the recording medium 1. During reproduction, an image is transferred from the recording medium 1 to the two-dimensional sensor 16 via the optical system. A variation in the magnification of the optical system, distortion, the contraction of the medium, or the like may occur between recording and reproduction. It is thus nearly impossible to match the positions of the pixels on the spatial modulator 14 during recording with the positions of the pixels on the two-dimensional sensor 16 during reproduction. Thus, the geometrical correction is carried out for each page of recording information using the marker positions as a reference. Specifically, on the basis of the difference between the original positions of the markers 42 on the spatial modulator 14 and the positions of the markers 42 detected based on the detected image data, the positions of the pixels included in the spatially-modulated image pattern 50 are corrected to generate detected information image data Ddet. The detected image data Ddet has digital values “0” and “1” corresponding to the spatially-modulated image pattern generated on the basis of the recording information and displayed on the spatial modulator 14 during recording.

The data demodulating unit 38 thus demodulates the detected information data already subjected to the geometrical correction using a demodulation system corresponding to the two-dimensional digital modulation system applied by the spatial modulator 14 during recording, and outputs the reproduced information data Dr corresponding to the recording data. The reproduced information data Dr subsequently undergoes postprocesses including error correction, de-interleaving, and de-scrambling.

On the other hand, in the servo system, the I-V converter 31 converts, into an output voltage, an output current from the quadruple photo detector 25, and the error signal generating unit 32 generates an error signal Se such as a tracking error signal and a focus error signal by a known method. The adder 33 compares the error signal Se with a predetermined reference signal Sref, and based on a comparison result thereof, the control circuit 34 generates a control signal Sc to supply it to the pickup 10. An actuator (not shown) in the pickup 10 controls a relative position of the objective lens 18 with respect to the recording medium 1 in a tracking direction and a focus direction on the basis of the control signal Sc. Thereby, the tracking servo and the focus servo are executed.

(Two-Dimensional Sensor)

Next, the description will be given of the two-dimensional sensor serving as the two-dimensional light-receiving element.

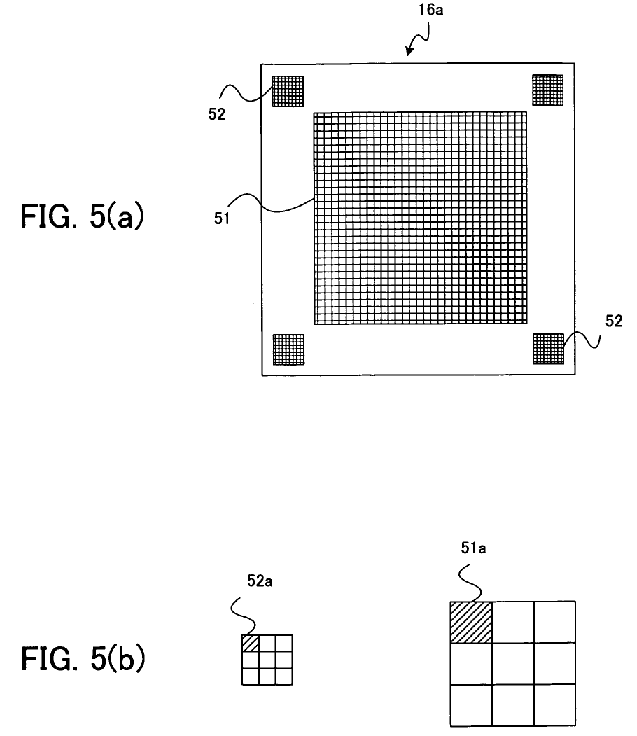

First, a first example of the two-dimensional sensor will be explained. FIGS. 5(a) and 5(b) show plan views of a two-dimensional sensor 16a according to the first example. The two-dimensional sensor 16a shown in FIG. 5(a) is constituted by a CCD or CMOS sensor, and has a data detecting area 51 arranged at the center and four marker detecting areas 52 arranged near four corners. The data detecting area 51 receives a component corresponding to the spatially-modulated image pattern 50 shown in FIG. 4, included in the detected light from the recording medium 1 during the reproduction, and outputs the detected information signal (analog signal) corresponding to the information data. On the contrary, each of the marker detecting areas 52 receives the component corresponding to each marker 42 shown in FIG. 4, included in the detected light from the recording medium 1 during the reproduction, and outputs the detected marker signal (analog signal). It is noted that both of the detected information signal and the detected marker signal are converted into the digital detected information data and the digital marker data by the subsequent data detecting unit 37, which will be explained later.

The data detecting area 51 and the marker detecting area 52 include the plural unit light-receiving elements arranged in the column and row directions of FIGS. 5(a) and 5(b), respectively. The two-dimensional sensor 16a according to the first example is characterized in that the size of the unit light-receiving element constituting the marker detecting area 52 is smaller than the size of the unit light-receiving area constituting the data detecting area 51. FIG. 5(b) is an enlarged diagram of portions of the marker detecting area 52 and the data detecting area 51. As shown in FIG. 5(b), the size of the unit light-receiving element 52a constituting the marker detecting area 52 is smaller than the size of the unit light-receiving element 51a constituting the data detecting area 51.

By making the size of the unit light-receiving element 52a in the marker detecting area 52 small, the spatial resolution of the marker detecting area 52 can be increased. Namely, in comparison with the data detecting area 51, the spatial resolution of the marker detecting area 52 becomes large. Thereby, the detection accuracy of the marker position can be improved. As described above, since the marker 42 is used as a reference for locating the detected light from the recording medium 1 at an appropriate position on the two-dimensional sensor 16, the reproduction accuracy of the information data recorded on the recording medium 1 is affected by the detection accuracy of the marker position. Therefore, in this example, by making the size of the unit light-receiving element 52a of the marker detecting area 52 smaller than the size of the unit light-receiving element 51a of the data detecting area 51, the detection accuracy of the marker position is improved.

In the two-dimensional sensor 16a according to the first example, since the data detecting area 51 and the marker detecting area 52 are separately arranged in terms of space, there is such an advantage that the detected information signal and the detected marker signal can be easily generated in a manner being separated from each other.

As an actual configuration of the above-mentioned two-dimensional sensor 16, as shown in FIG. 5(b), the unit light-receiving elements 52a whose areas are physically different from the unit light-receiving element 51a may be formed on the light-receiving surface of the two-dimensional sensor 16. Instead, by using the two-dimensional sensor having the size of the unit light-receiving element (i.e., physically minimum unit element size of the two-dimensional sensor) smaller than the size of the unit light-receiving element 52a of the marker detecting area 52 and by grouping the plural unit light-receiving elements, the unit light-receiving elements 52a of the marker detecting area 52 and the unit light-receiving elements 51a of the data detecting area 51 may be configured. For example, the unit light-receiving elements 52a of the marker detecting area 52 can be constituted by the four minimum unit elements of the two-dimensional sensor, and the unit light-receiving elements 51a of the data detecting area 51 can be constituted by the sixteen minimum unit elements of the two-dimensional sensor. According to the method, without the need of manufacturing the two-dimensional sensor having a special element configuration, by varying the unit of the photoelectric conversion of the normal two-dimensional sensor, such areas having different unit light-receiving element sizes can be configured, as shown in FIG. 5(a).

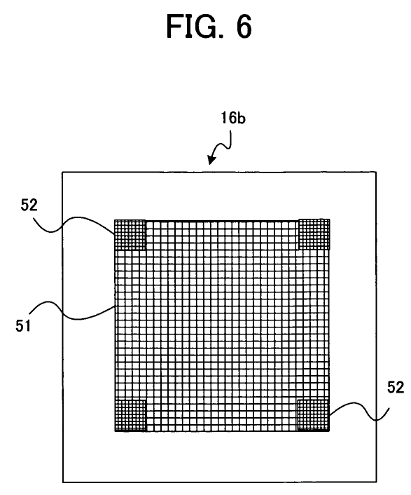

Next, the description will be given of a second example of the two-dimensional sensor. FIG. 6 shows a plan view of a two-dimensional sensor 16b according to the second example. The two-dimensional sensor 16a shown in FIG. 5(a) is such a type that the data detecting area 51 and the marker detecting areas 52 are separated. On the contrary, the two-dimensional sensor 16b shown in FIG. 6 is such a type that the marker detecting areas 52 are arranged inside the data detecting area 51 (at the four corners). In this example, the size of the unit light-receiving element in the marker detecting area 52 is smaller than the size of the unit light-receiving element in the data detecting area 51. Therefore, similarly to the example shown in FIG. 5(a), the detection accuracy of the marker position can be improved, too.

In addition, in the two-dimensional sensor 16b according to the second example, since the data detecting area 51 and the marker detecting area 52 are arranged adjacently to each other, the entire size of the light-receiving elements of the two-dimensional sensor 16b can advantageously be miniaturized.

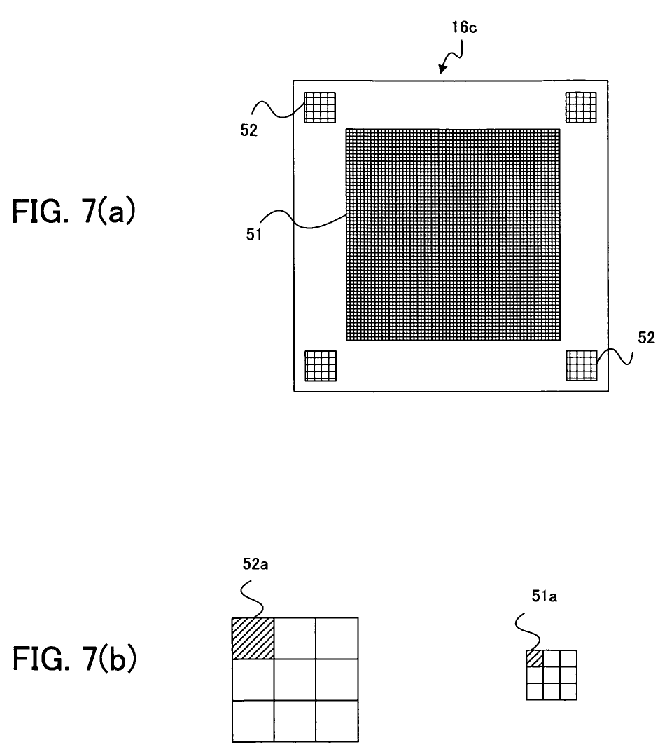

Next, the description will be given of a third example of the two-dimensional sensor. FIGS. 7(a) and 7(b) show plan views of the two-dimensional sensor 16c according to the third example. In the two-dimensional sensors 16a and 16b according to the above-mentioned first and second examples, the size of the unit light-receiving element 52a in the marker detecting area 52 is configured to be smaller than the size of the unit light-receiving element 51a in the data detecting area 51. Conversely, in the third example, the size of the unit light-receiving element 52a in the marker detecting area 52 is configured to be larger than the size of the unit light-receiving element 51a in the data detecting area 51. FIG. 7(b) schematically shows the state.

In the above first and second examples, by reducing the size of the unit light-receiving element 52a in the marker detecting area 52 to increase the spatial resolution, the detection accuracy of the marker position is improved. This technique is effective when the detected light from the recording medium 1 is irradiated on the light-receiving surface of the two-dimensional sensor equally and with sufficient light quantity. However, when the detected light is irradiated on the light-receiving surface of the two-dimensional sensor unequally and with insufficient light quantity, if the size of the unit light-receiving element 52a of the marker detecting area 52 is made smaller, a necessary S/N ratio cannot be maintained, and conversely the detection accuracy of the marker position is decreased.

In such the case, the two-dimensional sensor 16c according to the third example is preferable. In the two-dimensional sensor 16c according to the third example, since the size of the unit light-receiving element 52a in the marker detecting area 52 is made larger than the size of the unit light-receiving element 51a in the data detecting area 51, the light-receiving quantity for each unit light-receiving element 52a can be increased, and the S/N ratio can be maintained. As a result, the detection accuracy of the marker position can be improved.

In the two-dimensional sensor 16c according to the third example, similarly to the two-dimensional sensor 16a according to the first example, the data detecting area 51 and the marker detecting area 52 are separately arranged in terms of space. Therefore, there is such an advantage that the detected information signal and the detected marker signal can be easily generated in a manner being separated from each other.

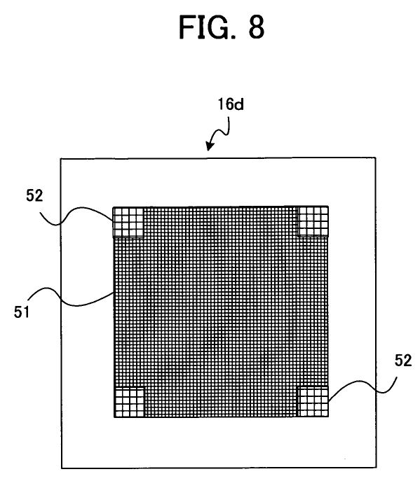

Next, the description will be given of a fourth example of the two-dimensional sensor. FIG. 8 shows a plan view of the two-dimensional sensor 16d according to the fourth example. In the two-dimensional sensor 16d, similarly to the two-dimensional sensor 16c according to the third example, the size of the unit light-receiving element 52a in the marker detecting area 52 is configured to be larger than the size of the unit light-receiving element 51a in the data detecting area 51. As a result, the S/N ratio in the marker detecting area 52 can be maintained, and the detection accuracy of the marker position can be improved.

In addition, in the two-dimensional sensor 16d according to the fourth example, similarly to the two-dimensional sensor 16b according to the second example, since the data detecting area 51 and the marker detecting area 52 are arranged adjacently to each other, the entire size of the light-receiving elements of the two-dimensional sensor 16d can advantageously be miniaturized.

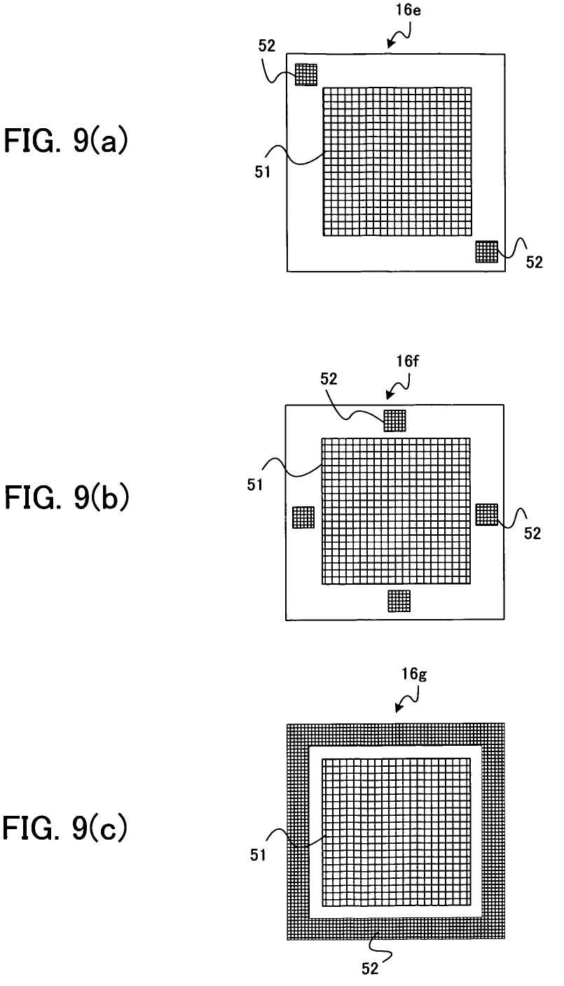

FIGS. 9(a) to 9(c) show other configuration examples of the two-dimensional sensor 16. In the above-mentioned first to fourth examples, the marker detecting areas 52 are arranged near the four corners of the data detecting area 51. However, the application of the present invention is not limited to this mode. For example, like the two-dimensional sensor 16e shown in FIG. 9(a), the marker detecting areas 52 may be arranged at the two corners diagonally oppositely located in the substantially square data detecting area 51. In the example shown in FIG. 9(a), the marker detecting areas 52 are arranged at the upper left and the bottom right positions in the data detecting area 51. However, the marker detecting areas 52 may be arranged at other two corners diagonally oppositely located, i.e., at the bottom left and the upper right positions in the data detecting area 51. In addition, in the example of FIG. 9(a), similarly to the first example, the marker detecting areas 52 are separated from the data detecting area 51. However, similarly to the second example, the marker detecting areas 52 may be arranged adjacently to the data detecting area 51.

A two-dimensional sensor 16f shown in FIG. 9(b) is an example that the marker detecting areas 52 are arranged near the mid-points of four sides, not at the four corners, of the data detecting area 51. Though the marker detecting area 52 is separated from the data detecting area 51 in the example of FIG. 9(b), the marker detecting area 52 may be arranged adjacently to the data detecting area 51.

A two-dimensional sensor 16g shown in FIG. 9(c) is an example that the marker detecting areas 52 are arranged in a frame-shape around all the four sides of the data detecting area 51. Also in this case, the marker detecting area 52 may be adjacent to the outer circumference of the data detecting area 51.

As explained above, in the two-dimensional sensor according to the present embodiment, since the sizes of the unit light-receiving element of the marker detecting area 52 and the data detecting area 51 are different, the detection accuracy of the marker position can be improved.

(Data Detection Process)

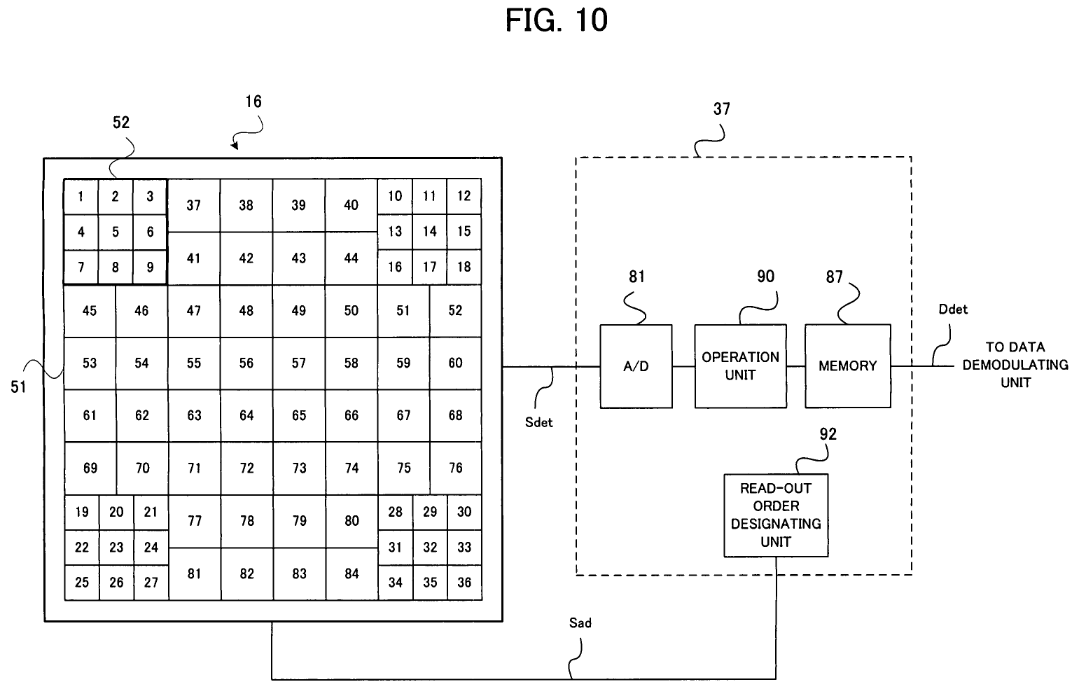

Next, the description will be given of a process of the detected information signal and the detected marker signal generated by the two-dimensional sensor 16. FIG. 10 schematically shows a configuration of the data detecting unit 37. The data detecting unit 37 receives the analog detected image signal Sdet from the two-dimensional sensor 16, and generates detected image data Ddet, which is the digital signal, to supply it to the data demodulating unit 38. The detected image signal Sdet includes the detected information signal and the detected marker signal, and the detected image data Ddet includes the detected information data and the detected marker data.

As shown in FIG. 10, the data detecting unit 37 includes an A/D converter 81, an operation unit 90, a memory 87 and a read-out order designating unit 92. The A/D converter 81 converts, into the digital signal (digital data), the detected image signal Sdet outputted from the two-dimensional sensor 16, and supplies it to the operation unit 90. Concretely, the A/D converter 81 converts the detected information signal in the detected image signal Sdet into the detected information data, and converts the detected marker signal in the detected image signal Sdet into the detected marker data. The operation unit 90 temporarily stores the detected information data and the detected marker data in the memory 87 and supplies them to the data demodulating unit 38. In this example, since the A/D converter 81 has an 8-bit length and the memory 87 has a 6-bit length, the operation unit 90 has to process the 8-bit detected information data and the 8-bit detected marker data to store them in the memory 87. The read-out order designating unit 92 designates the read-out order of the detected image signal Sdet from the two-dimensional sensor 16, which will be explained later.

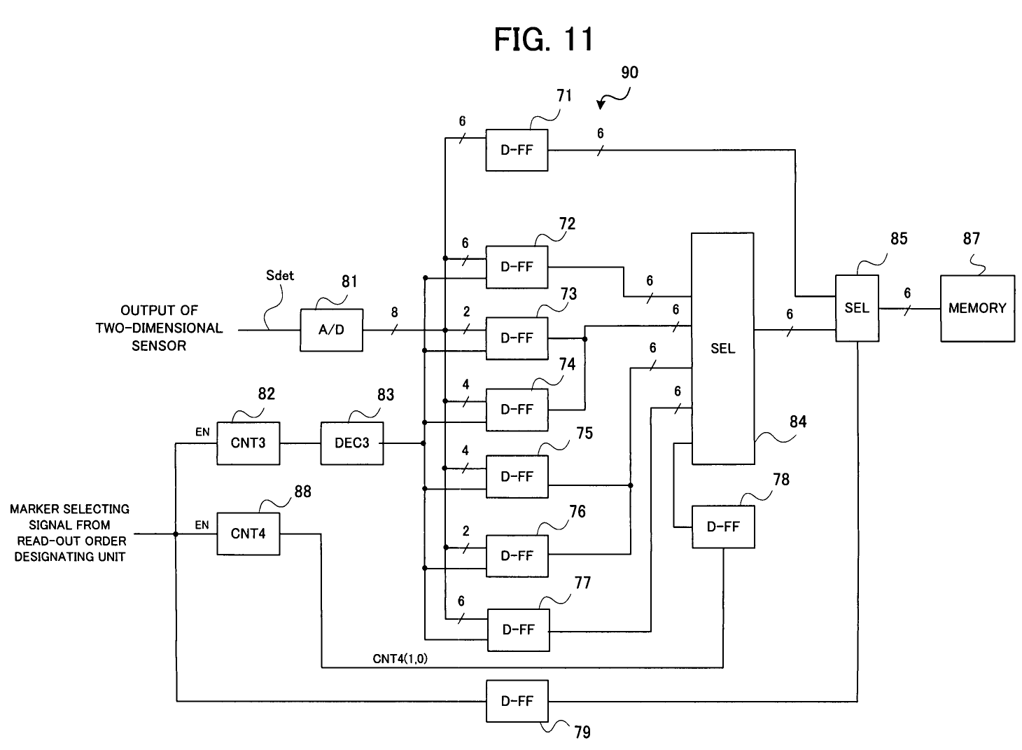

FIG. 11 shows a configuration of the operation unit 90. The operation unit 90 receives the 8-bit detected information data and the 8-bit detected marker data outputted from the A/D converter 81, and executes processes by prescribing that the bit length (word length) of the detected information data is 6 bits and the bit length (word length) of the detected marker data is 8 bits. Namely, by making the bit length of the detected marker data longer than the bit length of the detected information data, the accuracy of the detected marker data can be improved, and the detection accuracy of the marker position can also be improved.

Concretely, the operation unit 90 includes flip-flops (hereinafter referred to as “D-FF”) 71 to 79, a duodecimal counter 82, a decoder 83 and selectors 84 and 85. The D-FF 71 is used for the process of the detected information data, and the D-FFs 72 to 77 are used for the process of the detected marker data. The D-FF 78 generates a switching signal to the selector 84.

The detected image signal Sdet outputted from the two-dimensional sensor 16 is quantized to 8-bits by the A/D converter 81, and is outputted as the 8-bit detected information data and the 8-bit detected marker data D(7:0). The detected information data is supplied to the D-FF 71 for the information data, and the detected marker data is inputted to the D-FFs 72 to 77 for the marker data. The D-FF 71 is inserted in order to adjust the phases differences among the D-FFs 72 to 77.

The D-FFs 72 to 77 classify the 8-bit detected marker data outputted from the A/D converter 81 into groups by 6-bit unit, and stores them in the 6-bit-length memory 87. Concretely, the D-FFs 72 and 73, the D-FFs 74 and 75 and the D-FFs 76 and 77 store the 8-bit detected marker data D(7:0) in pairs, respectively. Out of the 8-bit detected marker data D(7:0) from the A/D converter 81, the upper 6 bits D(7:2) are supplied to the D-FF 72, and the lower 2 bits D(1:0) are supplied to the D-FF 73. Similarly, out of the 8-bit detected marker data D(7:0), the upper 4 bits D(7:4) are supplied to the D-FF 74, and the lower 4 bits D(3:0) are supplied to the D-FF 75. Further, out of the detected marker data D(7:0), the upper 2 bits D(7:6) are supplied to the D-FF 76, and the lower 6 bits D(5:0) are supplied to the D-FF 77.

The counters 82 and 88 operate by using a marker selecting signal from the read-out order designating unit 92 as an enable signal, and the counter 82 repeatedly counts count values “0” to “2”. The decoder 83 generates state signals of three states DEC_0, DEC_1 and DEC_2 from the count values, and inputs them to the respective D-FFs 72 to 77 as the enable signals. Thereby, the 8-bit detected marker data outputted from the A/D converter 81 is classified into four groups of 6-bit unit, and they are supplied to the 6-bit-length memory 87. Namely, as to the 8-bit detected marker data corresponding to the state signal DEC_0, the upper 6 bits are stored in the D-FF 72, and the lower 2 bits are stored in the D-FF 73. As to the 8-bit detected marker data corresponding to the state signal DEC_1, the upper 4 bits are stored in D-FF 74, and the lower 4 bits are stored in the D-FF 75. As to the 8-bit detected marker data corresponding to the state signal DEC_2, the upper 2 bits are stored in the D-FF 76, and the lower 6 bits are stored in the D-FF 77.

By repeating the above three states, the detected marker data is classified into the groups of 6-bit unit in order. The selector 84 selects the four groups of 6-bit data classified by the above method in order, and supplies them to the selector 85. As the switching signal of the selector 84, 2-bit CNT4 (1:0) being the output signal from the counter 88 may be used. The D-FF 78 is inserted in order to adjust the phases with respect to the D-FFs 72 to 77 which store the detected marker data.

Thus, the 8-bit detected marker data is supplied to the selector 85 by the 6-bit unit in order. The selector 85 selects the output from the selector 84 according to the marker selecting signal from the read-out order designating unit 92 during the output period of the detected marker data, and the detected marker data is stored in the memory 87. The D-FF 79 is inserted in order to adjust the phases with respect to the D-FFs 72 to 77.

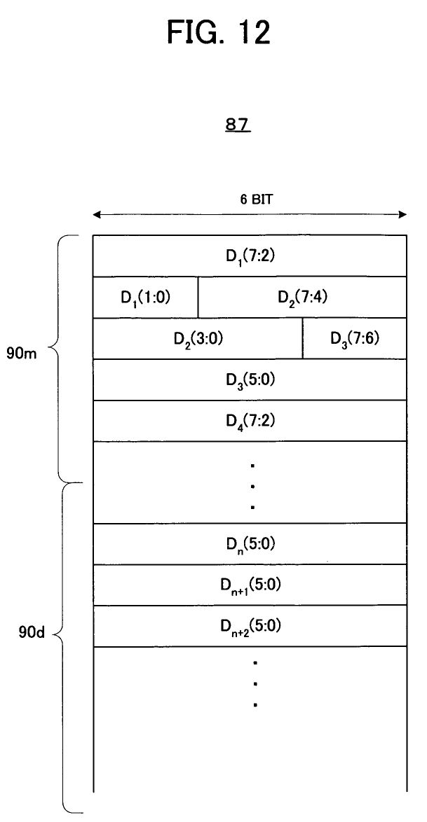

FIG. 12 schematically shows the storing state of the detected marker data in the memory 87. The memory 87 has the 6-bit length, and the detected marker data which is grouped into the 6-bit unit by the operation unit 90 is stored in a storing area 90m of the detected marker data.

On the other hand, out of the 8-bit detected information data outputted from the A/D converter 81, only the upper 6 bits are stored in the D-FF 71, and the lower 2 bits are disregarded or discarded. During the output period of the detected information data, since the selector 85 selects the output signal of the D-FF 71, the 6-bit detected information data is supplied to the memory 87, and is stored in a storing area 90d of the detected information data shown in FIG. 12.

Afterward, the detected marker data and the detected information data are supplied from the memory 87 to the data demodulating unit 38. The data demodulating unit 38 performs the marker position detection on the basis of the detected marker data, as described above. In addition, the data modulating unit 38 performs geometrical correction of the detected information data on the basis of the detected marker positions, and demodulates the information data to output it as reproduced information data Dr.

As described above, in the data detecting unit 37 of the present embodiment, the bit length of the detected marker data is 8 bit. Namely, the word length of the detected marker data is longer than the bit length (6 bit) of the detected information data. Thereby, the accuracy of the detected marker data can be improved, and the detection accuracy of the marker position executed in the data demodulating unit 38 can be improved. Further, by making the word length of the information data shorter than the word length of the marker data, the transmission speed of the information data can be increased. Thereby, the demand for improvements of both the detection accuracy of the marker position and the transmission speed of the information data is simultaneously satisfied.

Next, the description will be given of a read-out order of the detected image signal Sdet from the two-dimensional sensor 16. As described above, the detected marker data is used for detecting the marker positions, and the geometrical correction is performed on the basis of the detected marker positions. Therefore, it is preferable that the marker data is readout prior to the information data and early determination of the marker position is performed by the method such as the template matching, so that the subsequent process such as the geometrical correction can rapidly be started. Therefore, in the present embodiment, as the read-out order of the detected image signal Sdet from the two-dimensional sensor 16, first the detected marker signal is outputted, and then the detected information signal is outputted.

FIG. 10 schematically shows the read-out order of the detected image signal Sdet from the two-dimensional sensor 16. In FIG. 10, numbers indicating the read-out order are shown on the respective light-receiving elements on the two-dimensional sensor 16. The two-dimensional sensor 16 shown in FIG. 10 is the same type as the two-dimensional sensor 16b shown in FIG. 6, and the marker detecting areas 52 are arranged at the four corners of the data detecting area 51. In this example, the detected image signal Sdet is outputted in order from the light-receiving element at the upper left in the marker detecting area 52 at the upper left of the two-dimensional sensor 16 (read-out order “1” to “9”), and subsequently the detected image signal Sdet is outputted in order from the light-receiving element at the upper left in the marker detecting area 52 at the upper right (read-out order “10” to “18”). Similarly, the detected image signal Sdet is outputted in order from the light-receiving elements in the marker detecting area 52 at the lower left and in the marker detecting area 52 at the lower right (read-out order “19” to “36”). After the detected image signal Sdet is outputted from the marker detecting areas 52 in that way, the detected image signal Sdet is outputted in order from the light-receiving elements in the data detecting area 51 (read-out order “37” to “84”).

The designation of the read-out position in the two-dimensional sensor 16 is performed by the read-out order designating unit 92 in the data detecting unit 37. Namely, the read-out order designating unit 92 supplies, to the two-dimensional sensor 16, a signal Sad designating the position (address) of the light-receiving element on the two-dimensional sensor 16, and thereby the read-out order is controlled.

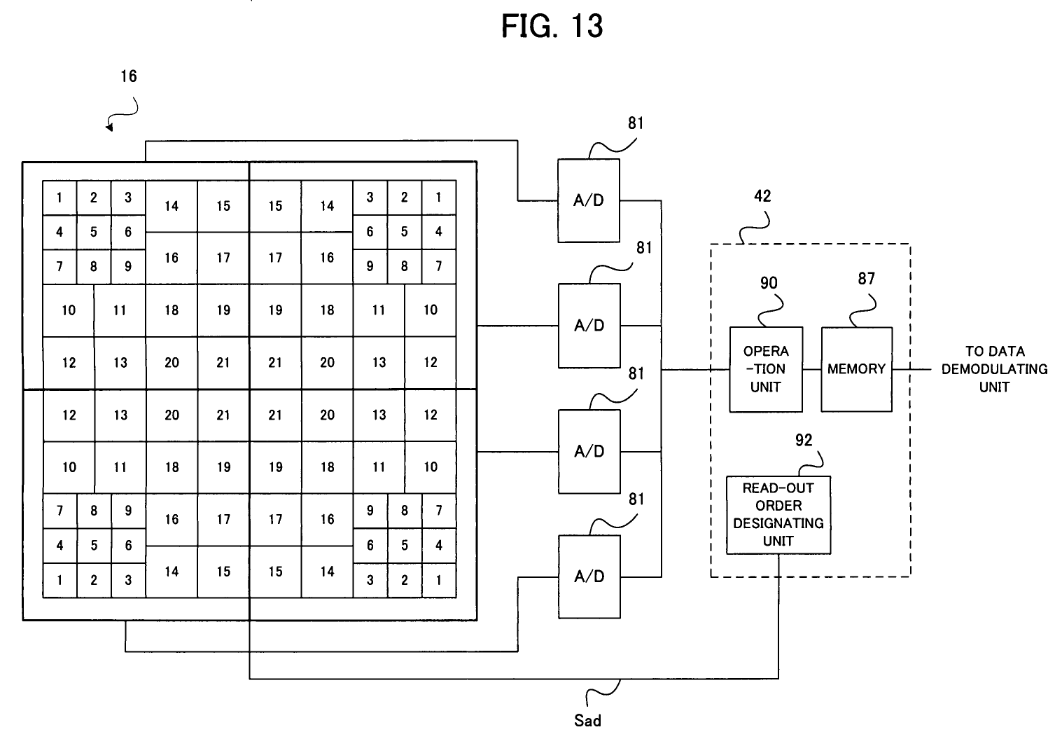

FIG. 13 shows another example of the data detecting unit 37. In this example, the two-dimensional sensor 16 is divided into four areas, i.e., upper-right, upper-left, lower-right and lower-left areas, and the A/D converter 81 is provided for each area. Since the process up to the A/D conversion can be executed in parallel by each area, a time necessary for the process can be shortened.

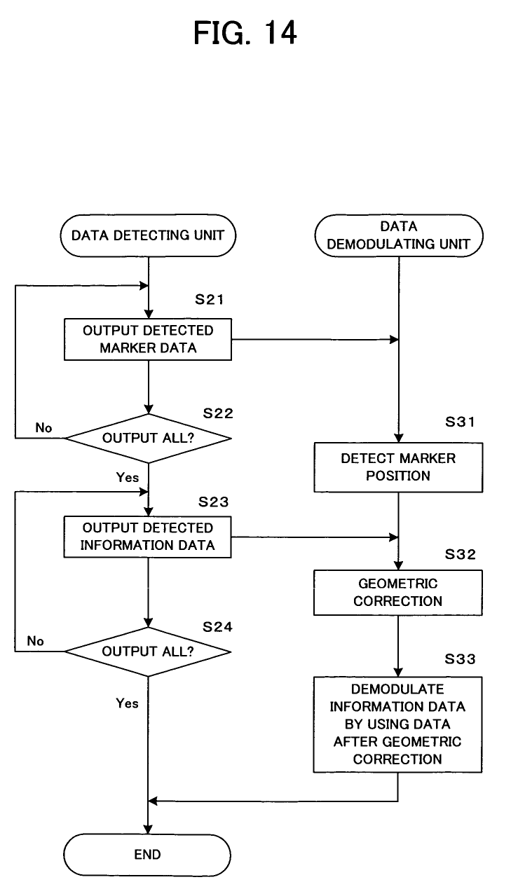

FIG. 14 shows a flow chart of a data detection process according to the present embodiment. It is noted that the process is mainly executed by the data detecting unit 37 and the data demodulating unit 38.

First, the read-out order designating unit 92 designates the marker detecting areas 52 of the two-dimensional sensor 16, and generates the detected marker signal. The data detecting unit 37 performs the A/D conversion and produces the detected marker data to supply it to the data demodulating unit 38 (step S21). On receiving the detected marker data, the data demodulating unit 38 starts the marker position detection process (step S31). In that way, the marker position detection process is executed in parallel with the output of the detected marker signal by the data detecting unit 37.

Next, when all the detected marker signals are outputted from the light-receiving elements in the marker detecting areas 52 (step S22; Yes), the read-out order designating unit 92 designates the data detecting area 51 of the two-dimensional sensor 16, and generates the detected information signal. The data detecting unit 37 performs the A/D conversion and produces the detected information data to supply it to the data demodulating unit 38 (step S23). In the data demodulating unit 38, when the detection of the marker positions is completed and the input of the detected information data is started, the geometrical correction is started (step S32). Therefore, the geometrical correction can be performed in parallel with the output of the detected information data from the data detecting unit 37. When the output of the detected information signal from the data detecting area 51 of the two-dimensional sensor 16 is completed (step S24; Yes), the process in the data detecting unit 37 ends. In addition, when the geometrical correction ends, the data demodulating unit 38 generates the reproduced information data by using the data after the geometrical correction and outputs the reproduced information data (step S33).

In the present embodiment, by reading out and obtaining the marker data prior to the information data, the detection of the marker position can be performed early, and the subsequent process such as the geometrical correction and the data demodulating process can be rapidly executed.

(Modification)

In the above-mentioned embodiment, in the data detecting unit 37, the detection accuracy of the marker position is improved by making the bit length (word length) of the detected marker data longer than the bit length of the detected information data. This technique is applicable regardless of the configuration of the two-dimensional sensor 16. Namely, though FIG. 10 shows such the two-dimensional sensor 16 that the sizes of the unit light-receiving elements of the marker detecting area 52 and the data detecting area 51 are different, the above technique is applicable to the optical recording and reproducing apparatus which uses such the two-dimensional sensor that the sizes of the unit light-receiving elements of the marker detecting area 52 and the data detecting area 51 are identical. Even though the sizes of the unit light-receiving elements of the marker detecting area 52 and the data detecting area 51 are identical, by making the bit length of the detected marker data longer than the bit length of the detected information data, the detection accuracy of the marker position can be improved.

In the above embodiment, though the read-out of the detected image signal from the light-receiving elements in the marker detecting area 52 is performed prior to the read-out of the detected image signal from the light-receiving elements in the data detecting area 51, the technique is applicable regardless of the configuration of the two-dimensional sensor 16. Namely, though FIG. 10 shows such the two-dimensional sensor 16 that the sizes of the unit light-receiving elements of the marker detecting area 52 and the data detecting area 51 are different, the above-mentioned technique is applicable to the optical recording and reproducing apparatus which uses such the two-dimensional sensor that the sizes of the unit light-receiving elements of the marker detecting area 52 and the data detecting area 51 are identical. Even though the areas of the unit light-receiving elements of the marker detecting area 52 and the data detecting area 51 are identical, by reading out the detecting signal from the marker detecting area prior to the read-out of the detecting signal from the data detecting area, the detection of the marker position can be performed early, and the subsequent process such as the geometrical correction and the data demodulating process can be rapidly executed.

In addition, the application of the present invention is not limited to the hologram recording method described in the above-mentioned embodiment. In the above embodiment, the object light and the reference light are generated in the optical system by using the light beam from the identical light source during the recording, for example. However, the application of the present invention is not limited to that. Even though the object light and the reference light are constitutionally irradiated on the recording medium as different light fluxes, for example, the present invention is applicable. Additionally, the application of the present invention is not limited to the hologram recording medium. The present invention is applicable to various kinds of optical recording and reproducing apparatuses, which use a recording and reproduction system that records the recording information as the two-dimensional image on the recording medium and reproduces the information as the detected light corresponding to the two-dimensional image, and in which the marker for correcting the position is recorded with the information data.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2004-818 filed on Jan. 6, 2004 including the specification, claims, drawings and summary is incorporated herein by reference in its entirety.

1. A two-dimensional light-receiving element which receives a detected light optically-modulated in accordance with a spatially-modulated pattern including a recording information image pattern corresponding to recording information and a marker, comprising:
a data detecting area which receives a component corresponding to the recording information image pattern in the detected light; and
a marker detecting area which receives a component corresponding to the marker in the detected light,
wherein a unit light-receiving element size of the marker detecting area is different from a unit light-receiving element size of the data detecting area.

2. The two-dimensional light-receiving element according to claim 1, wherein the unit light-receiving element size of the marker detecting area is smaller than the unit light-receiving element size of the data detecting area.

3. The two-dimensional light-receiving element according to claim 1, wherein the unit light-receiving element size of the marker detecting area is larger than the unit light-receiving element size of the data detecting area.

4. An optical reproducing apparatus comprising:
a two-dimensional light-receiving element which receives a detected light optically-modulated in accordance with a spatially-modulated pattern including a recording information image pattern corresponding to recording information and a marker; and
a reproducing unit which reproduces the recording information based on a detecting signal outputted from the two-dimensional light-receiving element,
wherein the two-dimensional light-receiving element comprises:
a data detecting area which receives a component corresponding to the recording information image pattern in the detected light; and
a marker detecting area which receives a component corresponding to the marker in the detected light,
wherein a unit light-receiving element size of the marker detecting area is different from a unit light-receiving element size of the data detecting area.

5. An optical reproducing apparatus comprising:
a two-dimensional light-receiving element which receives a detected light optically-modulated in accordance with a spatially-modulated pattern including a recording information image pattern corresponding to recording information and a marker;
a detecting unit which receives a component corresponding to the recording information image pattern in the detected light to output detected information data, and receives a component corresponding to the marker in the detected light to output detected marker data; and
a reproducing unit which reproduces the recording information based on the detected information data and the detected marker data,
wherein a bit length of the detected marker data is longer than a bit length of the detected information data.

6. The optical reproducing apparatus according to claim 5, wherein the detecting unit comprises:
an A/D converter which converts a detected information signal and a detected marker signal supplied from the two-dimensional light-receiving element into detected information data and detected marker data of a predetermined bit number, respectively; and
a unit which reduces the bit number of the detected information data to supply the detected information data of reduced bit number to the reproducing unit and supplies the detected marker data of the predetermined bit number to the reproducing unit.

7. An optical reproducing apparatus comprising:
a two-dimensional light-receiving element which receives a detected light optically-modulated in accordance with a spatially-modulated pattern including a recording information image pattern corresponding to recording information and a marker;
a detecting unit which receives a component corresponding to the recording information image pattern in the detected light to output detected information data, and receives a component corresponding to the marker in the detected light to output detected marker data; and
a reproducing unit which reproduces the recording information based on the detected information data and the detected marker data,
wherein the detecting unit outputs the detected marker data prior to the detected information data.

8. An optical reproducing method comprising:
a process which receives, by a two-dimensional light-receiving element, a detected light optically-modulated in accordance with a spatially-modulated pattern including a recording information image pattern corresponding to recording information and a marker;
a process which receives a component corresponding to the marker in the detected light and outputs detected marker data of a predetermined bit length;
a process which receives a component corresponding to the recording information image pattern in the detected light and outputs detected information data of a bit length shorter than the predetermined bit length; and
a process which reproduces the recording information based on the detected information data and the detected marker data.

9. An optical reproducing method comprising:
a process which receives, by a two-dimensional light-receiving element, a detected light optically-modulated in accordance with a spatially-modulated pattern including a recording information image pattern corresponding to recording information and a marker;
a process which receives a component corresponding to the marker in the detected light and outputs detected marker data;
a process which receives a component corresponding to the recording information image pattern in the detected light after outputting of the detected marker data, and outputs detected information data; and
a process which reproduces the recording information based on the detected information data and the detected marker data.

10. An optical recording and reproducing apparatus comprising:
a recording unit which records recording information on a recording medium as a recording information image pattern;
a two-dimensional light-receiving element which receives a detected light optically-modulated in accordance with a spatially-modulated pattern including a recording information image pattern corresponding to the recording information and a marker;
a detecting unit which receives a component corresponding to the recording information image pattern in the detected light to output detected information data, and receives a component corresponding to the marker in the detected light to output detected marker data; and
a reproducing unit which reproduces the recording information based on the detected information data and the detected marker data,
wherein a bit length of the detected marker data is longer than a bit length of the detected information data.

11. An optical recording and reproducing apparatus comprising:
a recording unit which records recording information on a recording medium as a recording information image pattern;
a two-dimensional light-receiving element which receives a detected light optically-modulated in accordance with a spatially-modulated pattern including a recording information image pattern corresponding to the recording information and a marker;
a detecting unit which receives a component corresponding to the recording information image pattern in the detected light to output detected information data, and receives a component corresponding to the marker in the detected light to output detected marker data;
a reproducing unit which reproduces the recording information based on the detected information data and the detected marker data,
wherein the detecting unit outputs the detected marker data prior to the detected information data.
